(19) United States
(12) Patent Application Publication
(10) Pub. No.: US 2026/0044435 A1
(43) Pub. Date: Feb. 12, 2026

(54) ASSESSMENT OF BROWSER EXTENSION IMPACTS ON BROWSER REAL USER MONITORING

(71) Applicant: Cisco Technology, Inc., San Jose, CA (US)

(72) Inventors: Najuka Prakash Sankhe, San Jose, CA (US); Jaideep Padhye, San Jose, CA (US)

(73) Assignee: Cisco Technology, Inc., San Jose, CA (US)

(21) Appl. No.: 18/797,163

(22) Filed: Aug. 7, 2024

(51) Int. Cl. G06F 11/36; G06F 11/34

(52) U.S. Cl. CPC G06F 11/3684; G06F 11/3457; G06F 11/3688

(57) ABSTRACT

In one implementation, a device may identify an active browser extension and browser attributes of a browser from which performance metrics are collected. The device may generate a testing configuration for the active browser extension based on the browser attributes. The device may test an impact of the active browser extension on the performance metrics utilizing the testing configuration in a testing environment. The device may provide an indication of the impact of the active browser extension on the performance metrics for display via a user interface.

### TECHNICAL FIELD

The present disclosure relates generally to computer networks, and, more particularly, to assessment of browser extension impacts on browser real user monitoring.

### BACKGROUND

Web browsers play a central role in user interactions across digital communication networks (e.g., the Internet). Web browser applications are increasingly utilized to perform real-user monitoring (RUM) by tracking key performance indicators through Web Vitals, a set of metrics that provide insight into the user experience. These metrics are crucial in providing direct insight into the responsiveness, stability, and efficiency of websites, web applications, etc. as experienced by real users. Despite their significance, current methodologies are focused on intrinsic web properties, overlooking external factors that may impair performance.

One such oversight is the impact of browser extensions on these metrics and/or the user experience. While these extensions provide enhanced functionality and customization, they can also significantly consume system resources such as memory, CPU, etc., thereby degrading the user experience. Overlooking these impacts may lead to incomplete and/or inaccurate performance evaluations. As a result, visibility into the performance and user experience associated with websites, web applications, etc. remains opaque and font end issue identification, error resolution, and digital experience improvement suffer.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example observability intelligence platform; and

FIG. 4 illustrates an example of an output of a browser real user monitoring metric collection utility;

FIG. 5 illustrates an example of flow diagram of an assessment of browser extension impacts on browser real user monitoring;

FIG. 6 illustrates an example of a browser extension performance impact characterization based on browser extension performance impact analysis;

FIG. 7 illustrates an example of device profiles which may be generated and/or utilized for assessment of browser extension impacts on browser real user monitoring (BRUM); and

FIG. 8 illustrates an example of a simplified procedure for the assessment of browser extension impacts on BRUM, in accordance with one or more implementations described herein.

### DESCRIPTION OF EXAMPLE IMPLEMENTATIONS

### Overview

According to one or more implementations of the disclosure, device may a device may identify an active browser extension and browser attributes of a browser from which performance metrics are collected. The device may generate a testing configuration for the active browser extension based on the browser attributes. The device may test an impact of the active browser extension on the performance metrics utilizing the testing configuration in a testing environment. The device may provide an indication of the impact of the active browser extension on the performance metrics for display via a user interface.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

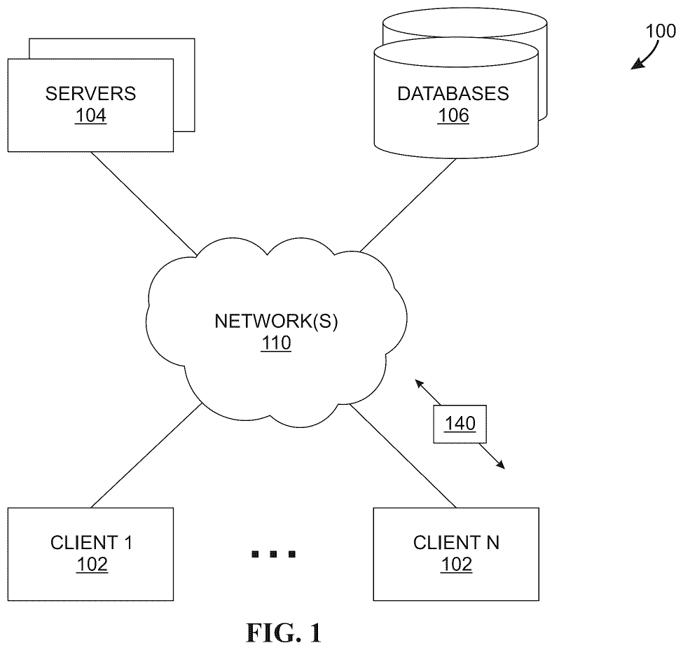

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IOT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

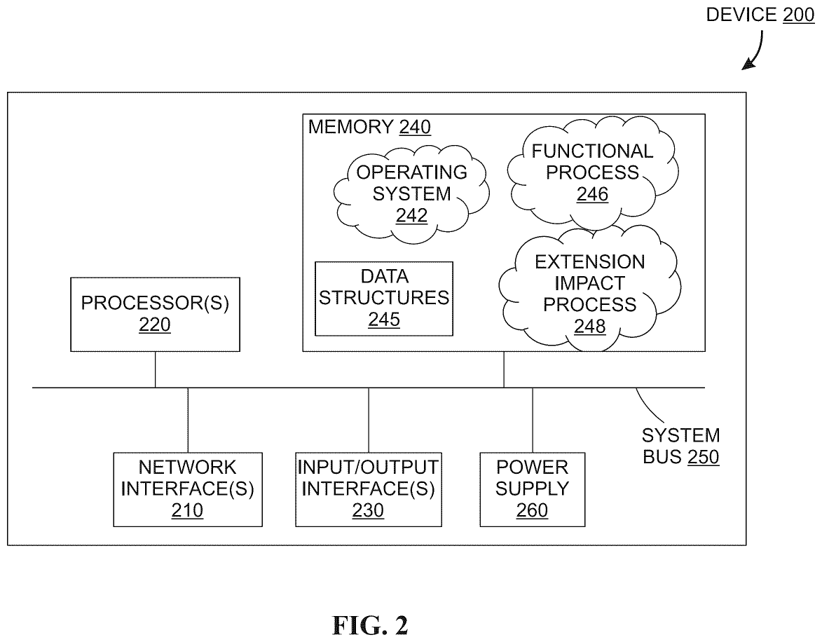

FIG. 2 is a schematic block diagram of an example of a node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a one or more functional processes (e.g., functional processes 246), and on certain devices, an illustrative process such as an extension impact process 248, as described herein. Notably, functional processes 246, when executed by processor 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, extension impact process 248 may include computer executable instructions that, when executed by processor 220, cause device 200 to perform the techniques described herein. To do so, in some implementations, extension impact process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, extension impact process 248 may employ one or more supervised, unsupervised, or semi-supervised machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that extension impact process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, extension impact process 248 may also include, or otherwise use, one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of assessing an performance impact of a browser extension, extension impact process 248 may use a generative model to identify, harvest, and analyze data points related to the performance and security implications of browser extensions, create detailed device profiles, generate specific testing setups that closely match what real users, etc. to facilitate the integration of browser extension impact into Core Web Vitals reporting. Example generative approaches can include, but are not limited to, generative adversarial networks (GANs), large language models (LLMs), other transformer models, and the like.

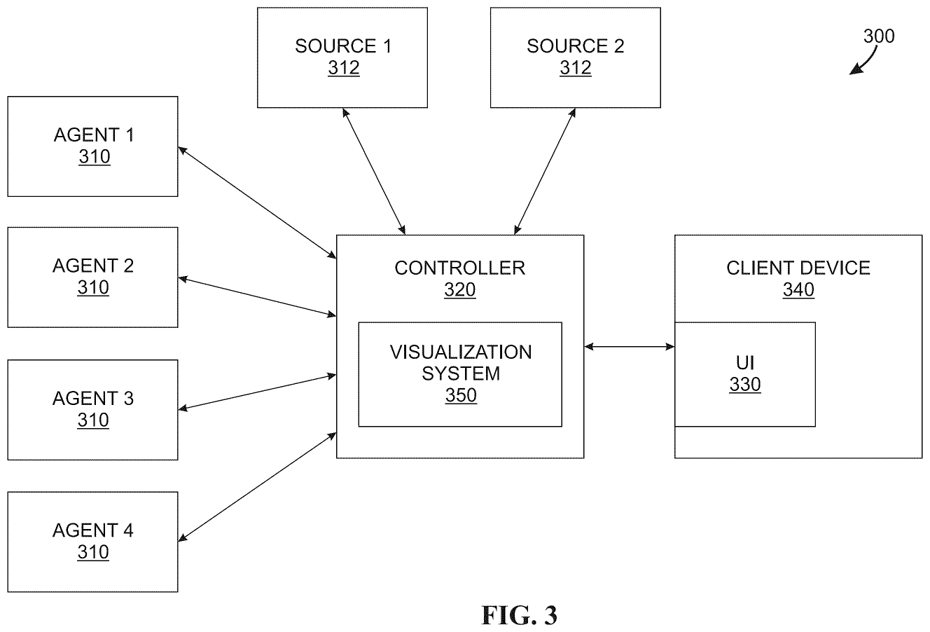

FIG. 3 is a block diagram of an example observability intelligence platform 300 that can implement one or more aspects of the techniques herein. The observability intelligence platform is a system that monitors and collects metrics of performance data for a network and/or application environment being monitored. At the simplest structure, the observability intelligence platform includes one or more agents (e.g., agents 310), one or more sources (e.g., sources 312), and one or more servers/controllers (e.g., controller 320). Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller 320 as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page—i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 320 is the central processing and administration server for the observability intelligence platform. The controller 320 may serve a user interface 330 (denoted UI in FIG. 3), such as a browser-based UI, that is the primary interface for monitoring, analyzing, and troubleshooting the monitored environment. Specifically, the controller 320 can receive data from agents 310, sources 312 (and/or other coordinator devices), associate portions of data (e.g., topology, transaction end-to-end paths and/or metrics, etc.), communicate with agents to configure collection of the data (e.g., the instrumentation/tests to execute), and provide performance data and reporting through user interface 330. User interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, an instance of controller 320 may be hosted remotely by a provider of the observability intelligence platform 300. In an illustrative on-premises (On-Prem) implementation, a controller 320 may be installed locally and self-administered.

The controllers 320 receive data from the agents 310 (e.g., Agents 1-4) and/or sources 312 deployed to monitor networks, applications, databases and database servers, servers, and end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application. Further, the controllers 320 can receive data from sources 312 (e.g., sources 1-2). Any of the sources can be implemented to provide various types of observability data that can include information, metrics, telemetry data, business data, network data, etc.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be implemented as small files using web-based technologies, such as JavaScript agents injected into each instrumented web page (e.g., as close to the top as possible) as the web page is served and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

Note further that in certain implementations, in the application intelligence model, a transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

An application transaction, in particular, is a representation of the particular service provided by the monitored environment that provides a view on performance data in the context of the various tiers that participate in processing a particular request. That is, an application transaction, which may be identified by a unique application transaction identification (ID), represents the end-to-end processing path used to fulfill a service request in the monitored environment (e.g., adding items to a shopping cart, storing information in a database, purchasing an item online, etc.). Thus, an application transaction is a type of user-initiated action in the monitored environment defined by an entry point and a processing path across application servers, databases, and potentially many other infrastructure components. Each instance of an application transaction is an execution of that transaction in response to a particular user request (e.g., a socket call, illustratively associated with the TCP layer). An application transaction can be created by detecting incoming requests at an entry point and tracking the activity associated with request at the originating tier and across distributed components in the application environment (e.g., associating the application transaction with a 4-tuple of a source IP address, source port, destination IP address, and destination port). A flow map can be generated for an application transaction that shows the touch points for the application transaction in the application environment. In one implementation, a specific tag may be added to packets by application specific agents for identifying application transactions (e.g., a custom header field attached to a hypertext transfer protocol (HTTP) payload by an application agent, or by a network agent when an application makes a remote socket call), such that packets can be examined by network agents to identify the application transaction identifier (ID) (e.g., a Globally Unique Identifier (GUID) or Universally Unique Identifier (UUID)). Performance monitoring can be oriented by application transaction to focus on the performance of the services in the application environment from the perspective of end users. Performance monitoring based on application transactions can provide information on whether a service is available (e.g., users can log in, check out, or view their data), response times for users, and the cause of problems when the problems occur.

In accordance with certain implementations, both self-learned baselines and configurable thresholds may be used to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or application transaction) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the extensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be implemented across multiple devices, on different devices, utilizing additional devices, and so on, and the views shown herein are merely simplified examples that are not meant to be limiting to the scope of the present disclosure.

As noted above, web browser applications may be utilized to track key performance indicators through Web Vitals, a set of metrics that provide insights into the user experience. However, in existing approaches these statistics typically do not account for the potential impact of browser extensions on memory, CPU usage, etc. Further, the presence of multiple active browser extensions can significantly affect performance, and this influence is not reflected in the standard Web Vitals measurements.

As a result, conventional BRUM metric collection approaches fail to provide any insight regarding the impact of these browser extensions on the Web Vitals measurements, resulting in inaccurate and/or misleading performance assessments as well as a lack of understanding about which extensions may be utilized and/or how they might be optimized for better performance. In short, the blind spot with respect to extension-related resource consumption and its impact on user experience translates to degraded application performance, an inability to accurately optimize applications to monitored real world user interactions, and/or an inability to configure extension utilization in a manner optimized for performance.

### —Assessment of Browser Extension Impacts on Browser Real User Monitoring—

In contrast, the techniques described herein are utilized to provide a comprehensive understanding of performance for browser applications, incorporating data indicating the extent to which browser extensions affect overall performance. This additional layer of analysis provided by these techniques provides a more complete picture of the factors contributing to the application's performance and therefore facilitates increases to application performance, the ability to accurately optimize applications to monitored real world user interactions, and/or the configuration of extension utilization optimized for performance. While these techniques may be utilized with Core Web Vitals, they are not so limited and can be extended to and/or incorporate other browser real user monitoring metrics.

In short, the techniques described herein may enhance browser performance monitoring by integrating browser extensions impact into Core Web Vitals (or other metric) reporting. Leveraging advanced open-telemetry instrumentation and sandbox environment to analyze browser extension impact, accurate insights may be provided into how extensions affect user experience.

Illustratively, the techniques described herein may be performed by hardware, software, and/or firmware, such as in accordance with extension impact process 248, which may include computer executable instructions executed by the processor 220 (or independent processor of interfaces 210) to perform functions relating to the techniques described herein.

Specifically, according to various implementations, device may a device may identify an active browser extension and browser attributes of a browser from which performance metrics are collected. The device may generate a testing configuration for the active browser extension based on the browser attributes. The device may test an impact of the active browser extension on the performance metrics utilizing the testing configuration in a testing environment. The device may provide an indication of the impact of the active browser extension on the performance metrics for display via a user interface.

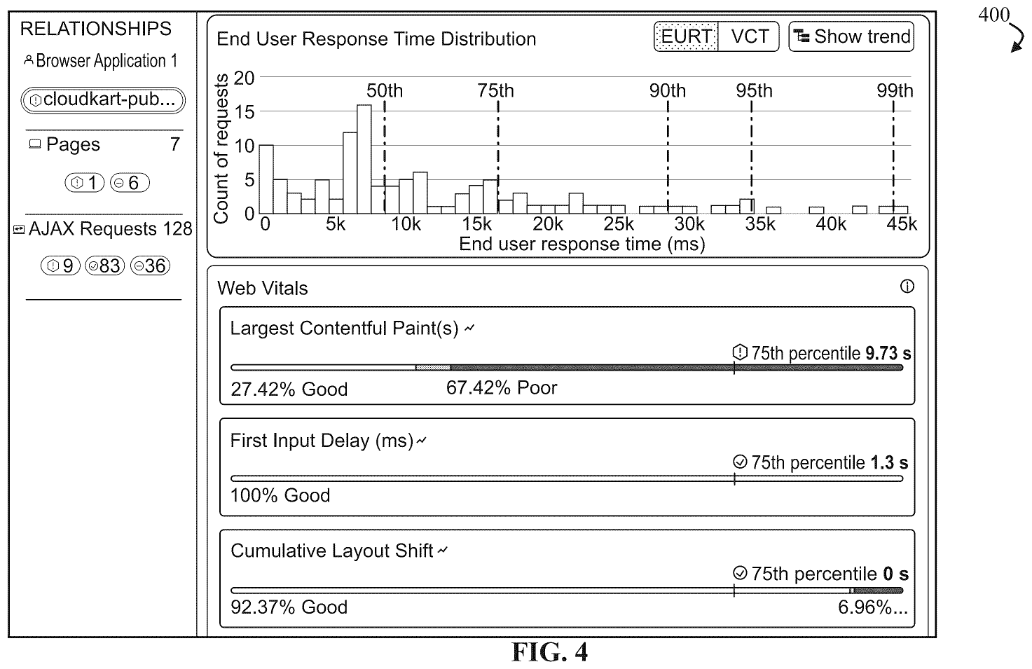

Operationally, FIG. 4 illustrates an example of an output 400 of a BRUM metric collection utility into which an assessment of browser extension impacts on browser real user monitoring may be integrated. Output 400 may be a monitoring environment dashboard displaying various web performance metrics. The dashboard may integrate standard Web Vitals (e.g., Largest Contentful Paint, First Input Delay, Cumulative Layout Shift, etc.), as well as a detailed view of end-user response time distribution.

In various implementations, output 400 may be enhanced with metrics that reflect the performance impact attributable to browser extensions. The inclusion of browser extensions' impact in the dashboard may provide a more holistic view of factors affecting browser performance. This may include presenting the impact as a percentage and specifying the number of browser extensions currently enabled. This may allow users to make more informed decisions regarding the management and optimization of browser extensions for improved performance.

This may be achieved by augmenting existing JavaScript (JS) agents that currently gathers Browser Real User Monitoring (BRUM) Web Vitals data. The JS agent may be enhanced to not only collect Core Web Vitals metrics but also to ascertain whether any browser extensions are active and gather data on their performance impact. This enhancement may configure the JS agent to serve as a comprehensive collector that feeds both traditional Web Vitals and browser extension performance data into the Cloud Native Observability platform (FSO). Through this integration, users may be presented with an enhanced output including detailed analysis of how browser extensions may be influencing their web experience, alongside the standard web vitals.

In addition, these techniques may introduce and leverage a browser extension dedicated to monitoring the performance of other browser extensions. This performance monitoring browser extension may be employed to collect and/or integrate the extension performance impact data. This specialized extension may activate upon page refresh or load, systematically collecting performance statistics of all active browser extensions. The data captured by this performance-monitoring extension may further enrich the information processed by the JS agent, providing an even clearer picture of the browser's operational landscape. By implementing these strategies, a more nuanced view of browser performance may be generated and delivered, incorporating the often-overlooked factor of extension-related resource consumption and its impact on user experience.

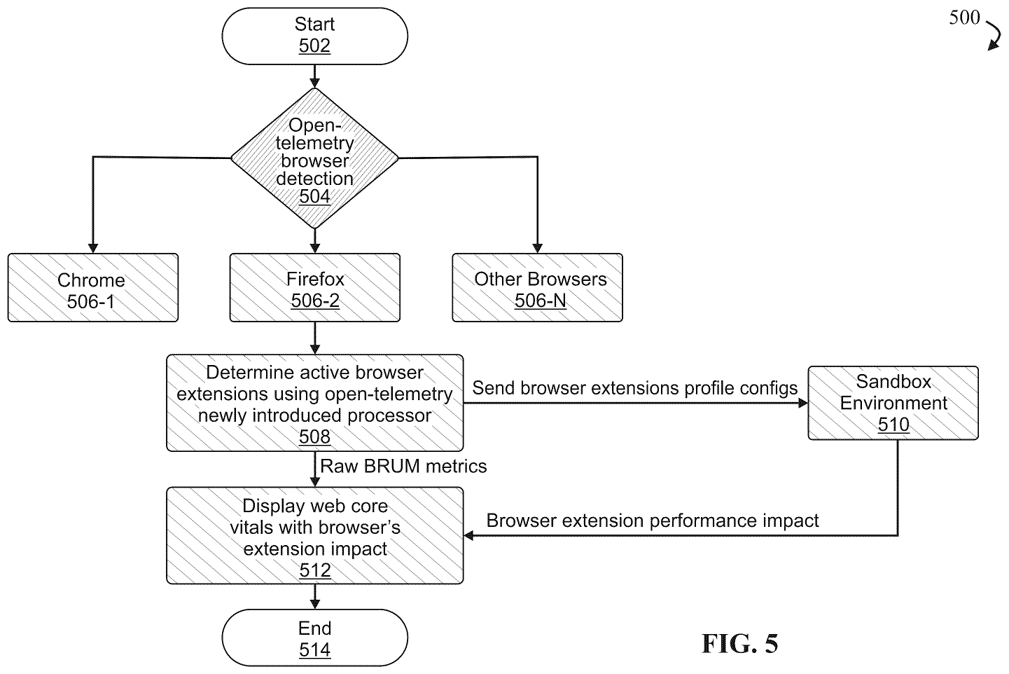

FIG. 5 illustrates an example of flow diagram 500 of an assessment of browser extension impacts on browser real user monitoring (BRUM). The assessment of browser extension impacts on BRUM may utilize frontend tracing in conjunction with a sandbox environment 510 to measure the impact of a browser extension's performance on real user monitoring metrics (e.g., Core Web Vitals, other real user monitoring metrics, etc.).

The assessment of browser extension impacts on BRUM may start at box 502, and continue to box 504, where an active browser may be identified. For example, frontend tracing may be utilized to determine if browser extensions are active. An OpenTelemetry (or other)-browser-detector may be utilized to facilitate the accurate identification of the active browser 506 (e.g., Chrome 506-1, Firefox 506-2, other browsers 506-N, etc.). Browser identification attributes may be added to resource spans when traces are created.

At box 508, depending on the type of browser detected, an assessment of which extensions are currently active may be performed. This may be accomplished by adapting an OpenTelemetry (or other)-sdk-trace-web to trace and record attributes specific to the browser extensions. Alternatively, this may also be achieved by adding getManifest implementation logic to retrieve browser extension details and ingest it as attributes. For example, implementation logic such as:

1^{▾} function getManifest( ) {
2 return browser != null && browser.runtime !=
null && browser.runtime.getManifest
!= null;
3 }
may be utilized.

The Performance.memory property and/or the Performance.measure. UserAgentSpecificMemory( ) API may be utilized to ascertain the memory usage of a browser extension. Furthermore, the navigator.hardwareConcuurency attribute may serve to evaluate the CPU consumption when a browser extension is active. Browser extensions profile configurations may be sent to sandbox environment 510.

The performance impact of each browser extension may be analyzed within sandbox environment 510. Precise measurements may be ensured within this controlled environment. The sandbox environment 510 may run two passes, one with a browser extension enabled and one without a browser extension enabled to generate a characterization or metric of the browser extension's performance impact.

At box 512, an assessment of the browser extension impacts on BRUM may be generated and/or presented to a user/administrator via a user interface. This assessment may be based on the raw BRUM metrics collected from the BRUM utility as well as the characterization or metrics of the browser extension's performance impact ascertained within the sandbox environment 510. That is, Core Web Vitals statistics presented on the user interface may incorporate the data regarding the performance impact of browser extensions as ascertained from the analysis conducted in sandbox environment 510.

The assessment of browser extension impacts on BRUM may end at box 514.

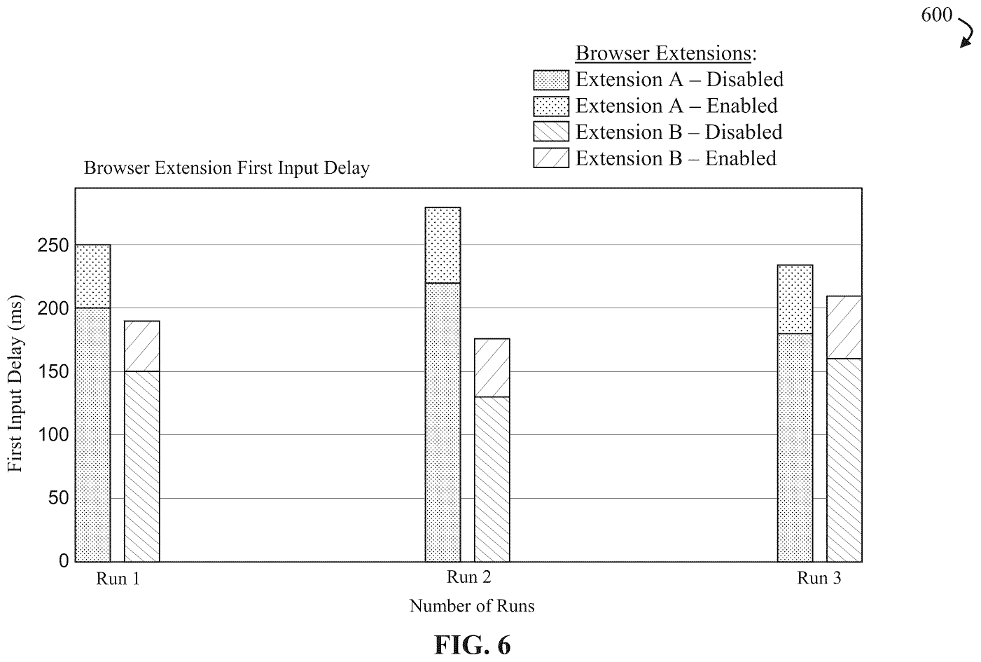

FIG. 6 illustrates an example of a browser extension performance impact characterization 600 based on browser extension performance impact analysis performed in a sandbox environment. The browser extension performance impact characterization 600 may be output to a user/administrator via a user interface and/or its underlying data may be utilized to generate and output additional characterizations of browser extension performance impacts.

Browser extension performance impact characterization 600 may be a characterization of browser extension first input delays attributable to the activity of one or more browser extensions. For example, browser extension performance impact characterization 600 graphically characterizes the input delay experienced with a first extension (Extension A) and a second extension (Extension B) enabled and disabled across multiple runs. By analyzing the first input delay measured in the sandbox environment when an extension is enabled versus disabled across multiple runs, a portion of the first input delay attributable to that extension may be identified. This data may be incorporated with and/or utilized to generate, modified, or annotate BRUM metric dashboards/reports to characterize browser extension performance impacts. This data may also be fed into secondary processes operable to generate testing setups that mimic real word setups, accurately optimize applications to monitored real world user interactions, and/or identify and deploy configurations of extension utilization that are performance optimized.

Collecting additional data attributes from browser extensions can indeed enhance the understanding of their impact on system performance and Core Web Vitals. By gathering details like browser version, CPU, and memory usage, developers and researchers can create more accurate profiles of extension behavior and their effects on user experience.

For instance, popular extensions like AdBlocker and Grammarly, when used by a large user base (e.g., 100,000 users), might have a significant impact on performance metrics like loading times, interactivity, and visual stability-key components of Core Web Vitals. By conducting controlled experiments in a sandbox environment, the performance degradation caused by these extensions may be accurately estimated. This data can then be overlaid with real-world Core Web Vitals statistics to predict the potential impact at scale.

Furthermore, by harvesting and analyzing the metadata attributes of browser extensions, external data sources may be cross-referenced to pinpoint any extensions with reported vulnerabilities. This may facilitate the creation of detailed reports on malicious extensions detected. Upon confirming an extension's malicious nature, it may be reported to the browser's web store and/or users may be directly alerted. In addition, the detection of malicious extensions may be utilized to trigger other automated threat mitigation processes.

This proactive approach may protect users from potential data theft or other security risks associated with malicious extensions. By systematically analyzing the performance and security implications of browser extensions, developers and users can make more informed decisions about which extensions to install and use, thus optimizing both the performance and security of their browsing experience.

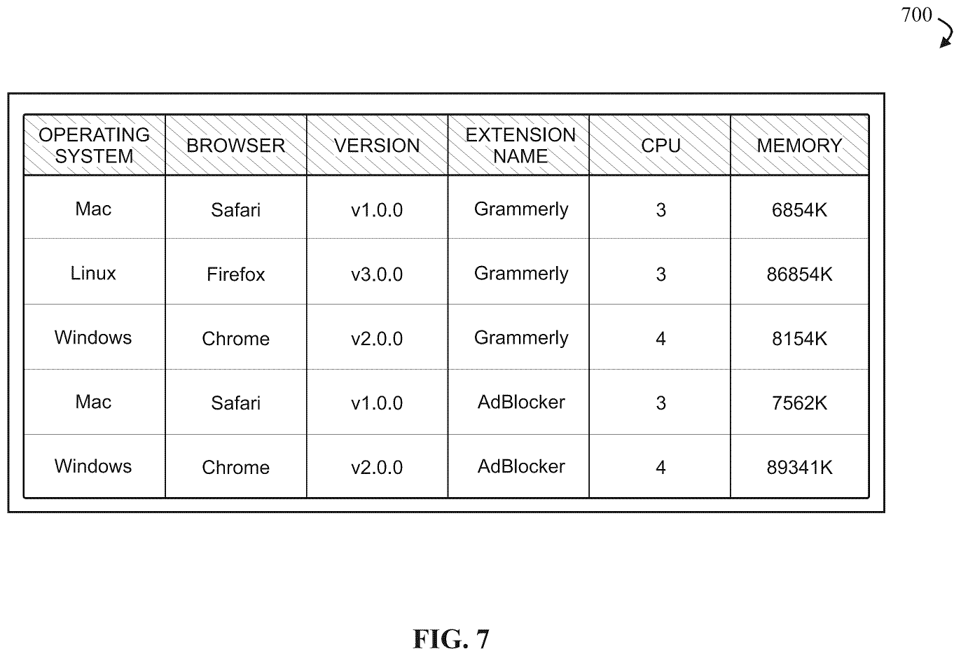

FIG. 7 illustrates an example of device profiles 700 which may be generated and/or utilized for assessment of browser extension impacts on BRUM. When collecting attributes to analyze browser performance, it may be imperative to capture a diverse set of data points, including browser type, browser version, device type, and operating system. This comprehensive data collection may facilitate the creation of detailed device profiles (e.g., device profiles 700), which can significantly enhance the accuracy of sandbox testing.

By using details like browser type, browser version, device type, and operating system, specific testing setups may be created that closely match what real users have. This may ensure that the resulting testing is detailed and provides information that's actually useful for understanding how well a website or application will work for different people operating different setups. For example, having precise device profiles such as “Linux running Chrome version 1.0.0,” “Mac with Safari version 1.1.1,” or “Windows operating Chrome version 1.3.0,” may allow testers to be configured to simulate and scrutinize the performance of web applications across distinct, yet common, combinations of technology stacks.

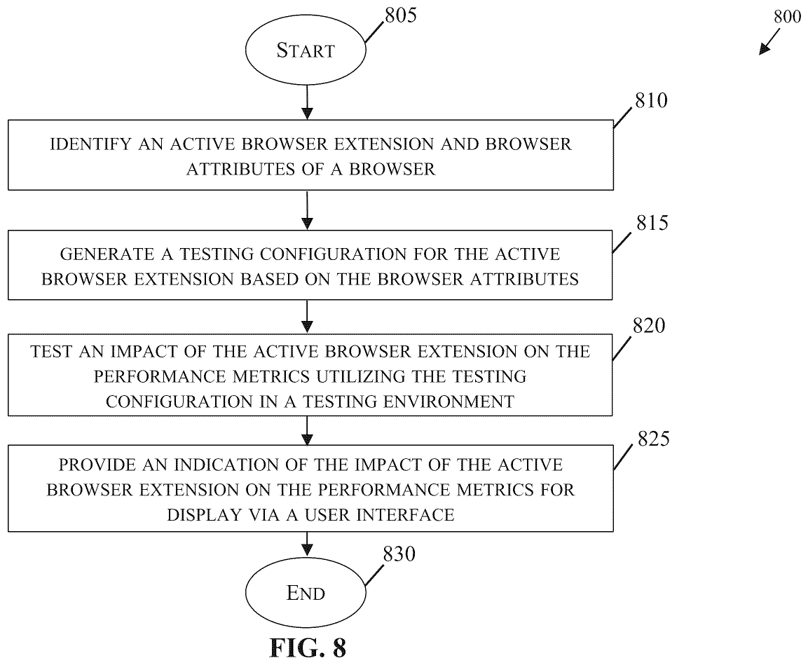

FIG. 8 illustrates an example of a simplified procedure for the assessment of browser extension impacts on BRUM, in accordance with one or more implementation described herein. For example, a non-generic, specifically configured device (e.g., device 200), may perform procedure 800 (e.g., a method) by executing stored instructions (e.g., extension impact process 248).

The procedure 800 may start at step 805, and continues to step 810, where, as described in greater detail above, the device (e.g., a controller, processor, etc.) may identify an active browser extension and browser attributes of a browser from which performance metrics are collected. The browser attributes of the active browser may be identified from a resource span populated by a telemetry tool instrumented within the active browser that is configured to capture browser attribute data during user sessions.

In various implementations, the active browser extension may be identified from attributes specific to active browser extensions provided as telemetry data from a telemetry tool instrumented within the active browser. In some instances, the active browser extension may be identified from metadata extracted from a manifest file using a getManifest implementation logic embedded in the browser and ingested as attributes. The browser attributes of the active browser may include one or more of a browser type, a browser version, a device type, and/or an operating system associated with the active browser.

At step 815, as detailed above, a device may generate a testing configuration for the active browser extension based on the browser attributes. Generating the testing configuration may include using details like browser type, browser version, device type, operating system, etc. to create specific testing setups within a sandbox environment that closely match what real users have.

At step 820, as detailed above, a device may test an impact of the active browser extension on the performance metrics utilizing the testing configuration in a testing environment. Testing the impact of the active browser extension on the performance metrics may include collecting first pass performance metrics during a first pass with the active browser extension enabled in the testing environment and/or collecting second pass performance metrics during a second pass with the active browser extension disabled in the testing environment. Then, the impact of the active browser extension on the performance metrics may be identified based on a differential between the first pass performance metrics and the second pass performance metrics.

At step 825, as detailed above, the device may provide an indication of the impact of the active browser extension on the performance metrics for display via a user interface. Providing the indication of the impact of the active browser extension on the performance metrics may include overlaying the indication of the impact of the active browser extension on the performance metrics on the performance metrics collected from the browser.

In various implementations, procedure 800 may include generating, based on the impact of the active browser extension on the performance metrics, a browser extension configuration for the browser configured to mitigate the impact of the active browser extension on the performance metrics. Further, procedure 800 may include identifying a security vulnerability associated with the active browser extension by cross-referencing the attributes specific to the active browser extensions against external data sources and/or providing an indication of the security vulnerability when detected.

Procedure 800 then ends at step 830.

It should be noted that while certain steps within procedure 800 may be optional as described above, the steps shown are merely examples for illustration, and certain other steps may be included or excluded as desired. Further, while a particular order of the steps is shown, this ordering is merely illustrative, and any suitable arrangement of the steps may be utilized without departing from the scope of the implementations herein.

The techniques described herein, therefore, enhance browser performance monitoring by integrating browser extensions impact into Core Web Vitals (or other metric) reporting. Leveraging advanced open-telemetry instrumentation and sandbox environment to analyze browser extension impact, these techniques provide accurate insights into how extensions affect user experience. These insights may then be leveraged to structure additional testing, generate extension configurations, accurately optimize application, website, browser, and/or extension performance, and/or trigger security actions.

While there have been shown and described illustrative implementations that provide for assessment of browser extension impacts on browser real user monitoring, it is to be understood that various other adaptations and modifications may be made within the spirit and scope of the implementations herein. For example, while certain implementations are described herein with respect to using particular elements, modules, components, architectures, etc. for the purposes of assessing browser extension impacts on browser real user monitoring, the elements, modules, components, architectures, etc. are not limited as such and may be used for other functions, in other arrangements, in other functional distributions, in other implementations, etc. In addition, while particular types of metrics (e.g., Core Web Vitals, etc.), browsers, extensions, etc. are shown and discussed, other suitable metrics browsers, extensions, etc. may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method, comprising:
identifying, by a device, an active browser extension and browser attributes of a browser from which performance metrics are collected;
generating, by the device, a testing configuration for the active browser extension based on the browser attributes;
testing, by the device, an impact of the active browser extension on the performance metrics utilizing the testing configuration in a testing environment; and
providing, by the device, an indication of the impact of the active browser extension on the performance metrics for display via a user interface.

2. The method of claim 1, wherein the browser attributes of the browser are identified from a resource span populated by a telemetry tool instrumented within the browser that is configured to capture browser attribute data during user sessions.

3. The method of claim 1, wherein the browser attributes of the browser include one or more of a browser type, a browser version, a device type, or an operating system associated with the browser.

4. The method of claim 1, wherein the active browser extension is identified from attributes specific to active browser extensions provided as telemetry data from a telemetry tool instrumented within the browser.

5. The method of claim 4, further comprising:
identifying a security vulnerability associated with the active browser extension by cross-referencing the attributes specific to the active browser extensions against external data sources; and
providing an indication of the security vulnerability.

6. The method of claim 1, wherein the active browser extension is identified from metadata extracted from a manifest file using a getManifest implementation logic embedded in the browser and ingested as attributes.

7. The method of claim 1, wherein testing the impact of the active browser extension on the performance metrics comprises:
collecting first pass performance metrics during a first pass with the active browser extension enabled in the testing environment; and
collecting second pass performance metrics during a second pass with the active browser extension disabled in the testing environment.

8. The method of claim 7, further comprising:
identifying the impact of the active browser extension on the performance metrics based on a differential between the first pass performance metrics and the second pass performance metrics.

9. The method of claim 1, wherein providing the indication of the impact of the active browser extension on the performance metrics includes overlaying the indication of the impact of the active browser extension on the performance metrics on the performance metrics collected from the browser.

10. The method of claim 1, further comprising:
generating, based on the impact of the active browser extension on the performance metrics, a browser extension configuration for the browser configured to mitigate the impact of the active browser extension on the performance metrics.

11. An apparatus, comprising:
one or more network interfaces to communicate with a network;
a processor coupled to the one or more network interfaces and configured to execute one or more processes; and
a memory configured to store a process that is executable by the processor, the process, when executed, configured to:
identify an active browser extension and browser attributes of a browser from which performance metrics are collected;
generate a testing configuration for the active browser extension based on the browser attributes;
test an impact of the active browser extension on the performance metrics utilizing the testing configuration in a testing environment; and
provide an indication of the impact of the active browser extension on the performance metrics for display via a user interface.

12. The apparatus as in claim 11, wherein the browser attributes of the browser are identified from a resource span populated by a telemetry tool instrumented within the browser that is configured to capture browser attribute data during user sessions.

13. The apparatus as in claim 11, wherein the browser attributes of the browser include one or more of a browser type, a browser version, a device type, or an operating system associated with the browser.

14. The apparatus as in claim 11, wherein the active browser extension is identified from attributes specific to active browser extensions provided as telemetry data from a telemetry tool instrumented within the browser.

15. The apparatus as in claim 14, the process further configured to:
identify a security vulnerability associated with the active browser extension by cross-referencing the attributes specific to the active browser extensions against external data sources; and
provide an indication of the security vulnerability.

16. The apparatus as in claim 11, wherein the active browser extension is identified from metadata extracted from a manifest file using a getManifest implementation logic embedded in the browser and ingested as attributes.

17. The apparatus as in claim 11, the process further configured to test the impact of the active browser extension on the performance metrics by:
collecting first pass performance metrics during a first pass with the active browser extension enabled in the testing environment; and
collecting second pass performance metrics during a second pass with the active browser extension disabled in the testing environment.

18. The apparatus as in claim 17, the process further configured to:
identify the impact of the active browser extension on the performance metrics based on a differential between the first pass performance metrics and the second pass performance metrics.

19. The apparatus as in claim 11, wherein the indication of the impact of the active browser extension on the performance metrics is provided by overlaying the indication of the impact of the active browser extension on the performance metrics on the performance metrics collected from the browser.

20. A tangible, non-transitory, computer-readable medium storing program instructions that cause a device to execute a process comprising:
identifying an active browser extension and browser attributes of a browser from which performance metrics are collected;
generating a testing configuration for the active browser extension based on the browser attributes;
testing an impact of the active browser extension on the performance metrics utilizing the testing configuration in a testing environment; and
providing an indication of the impact of the active browser extension on the performance metrics for display via a user interface.
